(19) United States
(12) Patent Application Publication
(10) Pub. No.: US 2025/0028762 A1
(43) Pub. Date: Jan. 23, 2025

(54) METHODS AND COMPUTER READABLE STORAGE MEDIA FOR SORTING AND RETRIEVING DOCUMENTS

(71) Applicant: SIMILARI LTD., Kfar Saba (IL)

(72) Inventors: Tommy SANDBANK, Herzliya (IL); Ori CALVO, Mazkeret Batya (IL); Ehud COHEN, Kfar Saba (IL)

(73) Assignee: SIMILARI LTD., Kfar Saba (IL)

(21) Appl. No.: 18/353,915

(22) Filed: Jul. 18, 2023

(51) Int. Cl. G06F 16/93

(52) U.S. Cl. CPC G06F 16/93

(57) ABSTRACT

Systems, methods, and computer storage media for sorting-in and sorting-out documents are described; the method includes: providing a query related to a subject of interest; searching the index of a document database and sorting-in documents comprising at least one data tag related to the query; displaying documents comprising at least one data tag related to the query; coupling preset interactive selector indicia, comprising a positive indicium and a negative indicium; detecting at least one including interaction with a negative indicium; predefining a threshold of similarity score; sorting-out from the set of negative data tags any data tags that do not attain the inclusion criterion of similarity score between the secondary set of negative data tags and the primary set of positive data tags, and excluding that that are associated with at least one data tag from the sorted-out negative data tags.

### TECHNOLOGICAL FIELD

In general, the presently disclosed subject matter pertains to computer science and the art of searching, sorting, and retrieving information. In particular, the invention relates to systems, methods, and computer readable storage media for combined sorting-in and sorting-out of documents, based on an interaction with a positive feedbacking indicium and/or negative feedbacking indicium, related to another document.

### BACKGROUND OF THE INVENTION

Filtering non-relevant documents out of a document database, while leaving only similar documents, is a common task. For example, such a search might be done in patent examination, human resources recruitment, searching for candidates by comparing their CV to an existing CVs, which is relevant for a specific job, searching for similar articles compared to a selected article. The problem is how to filter out the non-relevant documents, based on a non-relevant input document provided by the user, given a large document database, filtering in and leaving only the most relevant documents.

### SUMMARY OF THE INVENTION

The following summary of the invention is provided to exhibit the basic understanding of some principles, underlying various aspects and features of the invention. This summary is not an extensive overview of the invention and as such it is not necessarily intended to particularly identify all key or critical elements of the invention and is not to delineate the scope of the invention. Its sole purpose is to present some concepts of the invention in a simplified form, as a prelude to the following more detailed description.

According to some embodiments and aspects of the presently disclosed subject matter, there is provided a computer implemented method of searching, sorting, and retrieving documents.

According to some embodiments and aspects of the presently disclosed subject matter, the method comprises: providing an access to a database containing a plurality of documents with distinct content; indexing the database, thereby forming an index of the database, in which each one of the plurality of documents with the distinct content is associated with several data tags, from a repository of predefined data tags; inputting through a human-machine interface of a computer terminal a query related to a subject of interest, in which the query is at least one member selected from the group consisting of: a sematic query and input document; determining a primary set of positive data tags, from the repository of predefined data tags, related to the query; searching the index and sorting-in documents comprising at least one data tag from the primary set of positive data tags, related to the query, subsequently to the determining; selecting from the index a first group of documents, comprising at least one positive data tag from the primary set of positive data tags, related to the query, subsequently to the searching; displaying on a graphical user interface of a computer monitor at least a portion from the first group of documents, comprising at least one data tag from the primary set of positive data tags related to the query associated herewith in the index, subsequently to the selecting; defining preset interactive selector indicia, comprising a positive feedbacking indicium and a negative feedbacking indicium; coupling the preset interactive selector indicia to each one of the documents from the first group of documents, comprising at least one data tag from the primary set of positive data tags related to the query; detecting at least one feedback from the human-machine interface of the computer terminal, selected from the group consisting of: an interaction with the positive feedbacking indicium and interaction with negative feedbacking indicium; determining a secondary set of negative data tags, from the repository of predefined data tags, associated with a document in the database for which the interaction with the negative feedbacking indicium on the computer terminal human-machine interface has been detected, during the detecting; predefining a threshold of similarity score between: the secondary set of negative data tags, associated with the document in the database for which the interaction with the negative feedbacking indicium was detected, and the primary set of positive data tags related to the query, as an inclusion criterion for further searching; sorting-out from the secondary set of negative data tags, associated with the document in the database for which the interaction with the negative feedbacking indicium was detected, any data tags that do not attain the inclusion criterion of similarity score between the secondary set of negative data tags and the primary set of positive data tags, thereby forming a tertiary set of sorted-out negative data tags; refining the searching of the index, by a combination of: including any documents in the database that are associated with at least one data tag from the primary set of positive data tags related to the query, and excluding any documents in the database that that are associated with at least one data tag from the tertiary set of sorted-out negative data tags, associated with the document in the database for which the interaction with the negative feedbacking indicium was detected.

In some embodiments, a plurality of tags are summed-up into a singular vector.

In some embodiments, the similarity score between the secondary set of negative data tags and the primary set of positive data tags comprises a distance between a first vector representing the primary set of positive data tags and a second vector representing the secondary set of negative data tags.

In some embodiments, the similarity score is determined by a cosign similarity function, as an angular distance between the first vector and the second vector, disregarding the first vector and the second vector.

In some embodiments, the selecting of the first group of documents, further comprises determining that a similarity score, between a first vector collectively representing the primary set of positive data tags related to the query and a second vector collectively representing each one of the plurality of documents in the database, exceeds a predetermined threshold of inclusion criterion for primary searching.

In some embodiments, the preset interactive selector indicia comprise a graphical object, displayed on the graphical user interface of the computer monitor, in which at least the portion from the first group of documents is displayed.

According to some embodiments and aspects of the presently disclosed subject matter, there is provided a computer system for searching, sorting, and retrieving documents. The system comprises: a server comprising: computer-readable storage medium comprising: a database containing a plurality of documents with distinct content; a repository of predefined data tags; an index of the database, in which each one of the plurality of documents with the distinct content is associated with several data tags, from the repository; a microprocessor configured for: determining a primary set of positive data tags, from the repository of predefined data tags, associated with a query related to a subject of interest, in which the query is at least one member selected from the group consisting of: a sematic query and input document; searching the index and sorting-in documents comprising at least one data tag from the primary set of positive data tags, related to the query; selecting from the index a first group of documents, comprising at least one positive data tag from the primary set of positive data tags, related to the query, subsequently to the searching; defining preset interactive selector indicia, comprising a positive feedbacking indicium and a negative feedbacking indicium; coupling the preset interactive selector indicia to each one of the documents from the first group of documents, comprising at least one data tag from the primary set of positive data tags related to the query; detecting at least one feedback from the human-machine interface of the computer terminal, selected from the group consisting of: an interaction with the positive feedbacking indicium and interaction with negative feedbacking indicium; determining a secondary set of negative data tags, from the repository of predefined data tags, associated with a document in the database for which the interaction with the negative feedbacking indicium on the computer terminal human-machine interface has been detected, during the detecting; predefining a threshold of similarity score between: the secondary set of negative data tags, associated with the document in the database for which the interaction with the negative feedbacking indicium was detected, and the primary set of positive data tags related to the query, as an inclusion criterion for further searching; sorting-out from the secondary set of negative data tags, associated with the document in the database for which the interaction with the negative feedbacking indicium was detected, any data tags that do not attain the inclusion criterion of similarity score between the secondary set of negative data tags and the primary set of positive data tags, thereby forming a tertiary set of sorted-out negative data tags; refining the searching of the index, by including any documents in the database that are associated with at least one data tag from the primary set of positive data tags related to the query, and excluding any documents in the database that that are associated with at least one data tag from the tertiary set of sorted-out negative data tags, associated with the document in the database for which the interaction with the negative feedbacking indicium was detected.

According to some embodiments and aspects of the presently disclosed subject matter, the system comprises a computing device comprising: a human-machine interface device operationally connected to a computer terminal, configured for inputting the query; a computer monitor configured for displaying a graphical user interface including at least a portion from the first group of documents, comprising at least one data tag from the primary set of positive data tags related to the query associated herewith.

According to some embodiments and aspects of the presently disclosed subject matter, there is provided a computer-readable storage medium, having computer-executable instructions stored thereon which, when executed by a computer micro-processor of a system for searching, sorting, and retrieving documents, causing the micro-processor of the system: providing an access to an index of a document database, in which each one of the plurality of documents with the distinct content is associated with several data tags, from a repository of predefined data tags; inputting through a human-machine interface on a computer terminal a query related to a subject of interest, in which the query is at least one member selected from the group consisting of: a sematic query and input document; determining a primary set of positive data tags, from the repository of predefined data tags, related to the query; searching the index and sorting-in documents comprising at least one data tag from the primary set of positive data tags, related to the query, subsequently to the determining; selecting from the index a first group of documents, comprising at least one positive data tag from the primary set of positive data tags, related to the query, subsequently to the searching; displaying on a graphical user interface of a computer monitor at least a portion from the first group of documents, comprising at least one data tag from the primary set of positive data tags related to the query associated herewith in the index, subsequently to the selecting; defining preset interactive selector indicia, comprising a positive feedbacking indicium and a negative feedbacking indicium; coupling the preset interactive selector indicia to each one of the documents from the first group of documents, comprising at least one data tag from the primary set of positive data tags related to the query; detecting at least one feedback from the human-machine interface of the computer terminal, selected from the group consisting of: an interaction with the positive feedbacking indicium and interaction with negative feedbacking indicium; determining a secondary set of negative data tags, from the repository of predefined data tags, associated with a document in the database for which the interaction with the negative feedbacking indicium on the computer terminal human-machine interface has been detected, during the detecting; predefining a threshold of similarity score between: the secondary set of negative data tags, associated with the document in the database for which the interaction with the negative feedbacking indicium was detected, and the primary set of positive data tags related to the query, as an inclusion criterion for further searching; sorting-out from the secondary set of negative data tags, associated with the document in the database for which the interaction with the negative feedbacking indicium was detected, any data tags that do not attain the inclusion criterion of similarity score between the secondary set of negative data tags and the primary set of positive data tags, thereby forming a tertiary set of sorted-out negative data tags; refining the searching of the index, by a combination of: including any documents in the database that are associated with at least one data tag from the primary set of positive data tags related to the query, and excluding any documents in the database that that are associated with at least one data tag from the tertiary set of sorted-out negative data tags, associated with the document in the database for which the interaction with the negative feedbacking indicium was detected.

### Definitions

The term data tag, as referred to herein, is to be construed as encompassing any string of text, associating a qualifier or attribute with a data item. Data tags may describe labels attached to a data item for identification or other purposes and may be used to categorize or otherwise provide information about a document or about content that may be of interest to a content consumer. A data tag may be used in conjunction with text, image(s), video(s), animation, etc. In various examples, the data tag may be contained within the data item, appended to the data item, or stored as metadata. The metadata tag may be stored with the data item or may be stored in a separate data structure or storage location. A data tag in a non-limiting manner may include: a term, class, category, value, number, serial number, date, patent class, trademark class, trademark, subject, name, title, tradename, industry standard, geographical location, event, hashtag, article, URL, website, date, time, etc.

The term document, as referred to herein, is to be construed as encompassing any text structure that includes a representation of a word (e.g., “microscope”) or printable characters (e.g., “01.01.2020”) that convey some semantic and/or informative meaning. The document may be a physical sheet of paper or another tangible medium, as well as an electronic document. The electronic document may be in a proprietary or standard format, such as a Portable Document Format (PDF), a fax or scanned copy of a document, a word processor file, a database entry or a plain text file. The electronic document may be stored in memory or on a storage device using appropriate coding, and may also be encrypted. Text documents may include non-text content, such as images other than text images, but the content described herein optionally relates only to the text content portion of a document. Text documents may be considered to belong to a class. Non-limiting examples of categories may include: printed press, prices, news reports, patent publications, historical records, etc. In some examples of the disclosed technology implements a classifier that is appropriate for a particular class of documents, which may co-exist with classifiers for other classes of documents.

The term vector, as referred to herein, is to be construed as including any numerical expression of any plurality of tags.

The term feature vector, as referred to herein, is to be construed as any manner of mapping documents wherein the relationship of keywords to fields or keywords to other keywords is mapped both as to physical distance and direction.

The term/s similarity and/or distance, as referred to herein, is to be construed as any including mathematical expression or model configured to determine the extent of similarity and/or distance between any two vectors. An example of a mathematical model configured to determine the extent of similarity and/or distance between any two vectors is a cosine similarity, which is defined herein as a measure of similarity between two sequences of numbers. For defining the cosine similarity, the sequences are viewed as vectors in an inner product space, and the cosine similarity is defined as the cosine of the angle between them, that is, the dot product of the vectors divided by the product of their lengths. It follows that the cosine similarity does not depend on the magnitudes of the vectors, but only on their angle.

The meaning of the term Location Diagram, as referred to herein, may explained by the following example. Each file is present in three formats: (1) the original tiff image format; (2) the text format from simple OCR output, and (3) a grid format, i.e., a text pictorial representation of the document. All three formats can be used in classification and extraction. Assuming that A, B, C, D and E are five phrases, the overall representation that may come in a single feature-vector may be represented as follows: (1) A and B form a meaning X; (2) A is primary key; (3) B is p columns and q rows away from A, and (4) with similar information about other key phrases being recorded. These overall positions form a Location Diagram. The Location Diagram is optionally a relative position map of key phrases represented in unique way by their vectors of relative distances. The structured files are represented. in flexible structure maps called grid files.

The term printed circuit board and/or acronym PCB, as referred to herein, is to be construed as encompassing any type of a circuit board, not intended to limit to any particular board type or production technique, including, inter alia, non-printed circuit boards. device. The term printed circuit board and/or acronym PCB particularly include any type of structure configured to mechanically support and/or electrically connect electric and electronic components, such as: Printed Wire Boards (PWB), Printed Circuit Assemblies (PCA), Printed Circuit Board Assemblies (PCBA), Circuit Card Assemblies (CCA), Flexible Circuit Boards (FCB), integrated circuits (IC), monolithic integrated circuits (often referred to as a chips or microchips), chipsets and etc. The term printed circuit board and/or acronym PCB optionally include embedded software, written to control machines or devices that are not typical computers. Embedded software is specialized for a particular hardware and sometimes used interchangeably with the term firmware. A characteristic of embedded software is that no or at least not all functions thereof are initiated and/or controlled via a human interface but rather through machine-interfaces instead.

The term microcontroller controller unit and/or acronym MCU, as referred to herein, is to be construed as encompassing any type of a small computer on a single integrated circuit. MCU is typically similar to, but less sophisticated than, a system on a chip (SoC); an SoC may include a microcontroller as one of its components. An MCU contains one or more CPUs (processor cores) along with memory and programmable input/output peripherals. Program memory in the form of ferroelectric RAM, NOR flash or OTP ROM is also often included on chip, as well as a small amount of RAM. MCUs are designed for embedded applications, in contrast to the microprocessors used in personal computers or other general-purpose applications consisting of various discrete chips.

The term storage, as referred to herein, is to be construed as including one or more of volatile or non-volatile memory, hard drives, flash storage devices and/or optical storage devices, e.g., CDs, DVDs, etc. The term computer-readable media, as referred to herein, can include transitory and non-transitory computer-readable instructions, whereas the term computer-readable storage media includes only non-transitory readable storage media and excludes any transitory instructions or signals. The terms computer-readable media and computer-readable storage media encompass only a computer-readable media that can be considered a manufacture (i.e., article of manufacture) or a machine. Computer-readable storage media includes computer-readable storage devices. Examples of computer-readable storage devices include volatile storage media, such as RAM, and non-volatile storage media, such as hard drives, optical discs, and flash memory, among others.

The term computing device or alike, as referred to herein, is to be construed as including, in its most basic configuration, at least one processing unit and a memory. Depending on the exact configuration and type of computing device, the memory may be volatile, such as random access memory (RAM), non-volatile, such as read-only memory (ROM), flash memory, etc., or any combination thereof.

The term portable computing device, as referred to herein, is to be construed as including any type of mobile personal devices, such as smartphones, tablets, personal digital assistant (PDA) devices or personal portable computers, colloquially also known as notebooks or laptops. Portable computing devices are typically configured to perform data communication over telecommunication or cellular networks, as well as usually enabled with automated geolocation services.

Whenever the terms server, agent, system or module is used herein, it should be construed as a computer program, including any portion or alternative thereof, e.g., script, command, application programing interface (API), graphical user interface (GUI), etc., and/or computational hardware components, such as logic devices and application integrated circuits, computer storage media, computer micro-processors and random access memory (RAM), a display, input devices and networking terminals, including configurations, assemblies or sub-assemblies thereof, as well as any combination of the former with the latter.

The term integrated shall be construed, inter alia, as operable on the same machine and/or executed by the same computer program. Depending on the actual deployment of the method, its implementation and topology, integration of agents and/or integration into modules as well as the terms transfer, relaying, transmitting, forwarding, retrieving, accessing, pushed or similar refer to any interaction between agents via methods including, but not limited to, function calling, Application Programming Interface (API), Inter-Process Communication (IPC), Remote Procedure Call (RPC) and/or communicating using of any standard or proprietary protocol, such as SMTP, IMAP, MAPI, OMA-IMPS, OMA-PAG, OMA-MWG, SIP/SIMPLE, XMPP, SMPP.

The term network, as referred to herein, should be understood as encompassing any type of computer and/or data network, in a non-limiting manner including one or more intranets, extranets, local area networks (LAN), wide area networks (WAN), wireless networks (WIFI), the Internet, including the world wide web, and/or other arrangements for enabling communication between the computing devices, whether in real time or otherwise, e.g., via time shifting, cashing, batch processing, etc.

The terms notification and/or message as used herein refer to a communication provided by a notification system to a message recipient device. A notification and/or message may be used to inform one or more recipient device, for example a notification and/or messages may be provided to the one or more recipient device, in a non-limiting manner using SMS texts, MMS texts, E-mail, Instant Messages, mobile device push notifications, HTTP requests, voice calls, telephone calls, Voice Over IP (VOIP) calls or alike, library function calls, API calls, URLs as well as any signals transferred, transmitted or relayed, as defined herein or any combination thereof.

The terms levels, as referred to herein, should be understood as complementary levels of analysis, known in cognitive science as Marr's Tri-Level Hypothesis, including a high-level or computational level, concerned with what does the system do or what problems does it solve or overcome and alike, why does it do these things; an algorithmic level or representational level, concerned with how does the system do what it does, specifically, what data does it use and what processes does it employ to build and manipulate the data; and an implementational or physical level, concerned with how is the process physically realized and set forth to actual implementation, as detailed by Dawson, Michael RW at al. in Understanding Cognitive Science, by Blackwell Publishing, 1998 Nov. 2.

The term relational database, as referred to herein, should be construed as any digital database based on the relational model of data, as proposed by E. F. Codd in 1970. A software system used to maintain relational databases is a Relational Database Management System (RDBMS). Typically, relational database systems use Structured Query Language (SQL) for querying and maintaining the database.

The term real-time as referred to herein shall be construed as including a reasonable acceptable delay, without breaking communication and/or stopping the fluent exchange of messages and/or correlation to occurred event. In some embodiments real-time is limited to the range between zero to about 15 seconds, after which a near real-time period begins that typically lasts for up to a minute but in some instances can last until several minutes.

The term learning as referred to herein is to be construed as including the identification and training of suitable algorithms to accomplish tasks of interest. The term learning includes, but is not restricted to, association learning, classification learning, clustering, and numeric prediction.

The term machine learning as used herein refers to the field of the computer sciences that studies the design of computer programs able to induce patterns, regularities, or rules from past experiences to develop an appropriate response to future data, or describe the data in some meaningful way. By “machine learning” algorithms, in the context of this invention, it is meant association rule algorithms (e.g., Apriori, discriminative pattern mining, frequent pattern mining, closed pattern mining, colossal pattern mining, and self-organizing maps), feature evaluation algorithms (e.g., information gain, Relief, ReliefF, RReliefF, symmetrical uncertainty, gain ratio, and ranker), subset selection algorithms (e.g., wrapper, consistency, classifier, correlation-based feature selection CFS), support vector machines, Bayesian networks, classification rules, decision trees, neural networks, instance-based algorithms, other algorithms that use the herein listed algorithms (e.g., vote, stacking, cost-sensitive classifier) and any other algorithm in the field of the computer sciences that relates to inducing patterns, regularities, or rules from past experiences to develop an appropriate response to future data, or describing the data in some meaningful way.

The term learning model as referred to herein is to be construed as including a collection of parameters and functions, where the parameters are trained on a set of training samples. The parameters and functions may be a collection of linear algebra operations, non-linear algebra operations, and tensor algebra operations. The parameters and functions may include statistical functions, tests, and probability models. The training samples can correspond to samples having measured properties of the sample, as well as known classifications/labels. The model can learn from the training samples in a training process that optimizes the parameters (and potentially the functions) to provide an optimal quality metric (e.g., accuracy) for classifying new samples. The training function can include expectation maximization, maximum likelihood, Bayesian parameter estimation methods such as markov chain monte carlo, gibbs sampling, hamiltonian monte carlo, and variational inference, or gradient based methods such as stochastic gradient descent and the Broyden-Fletcher-Goldfarb-Shanno (BFGS) algorithm. Example parameters include weights (e.g., vector or matrix transformations) that multiply values, e.g., in regression or neural networks, families of probability distributions, or a loss, cost or objective function that assigns scores and guides model training. Example parameters include weights that multiple values, e.g., in regression or neural networks. A model can include multiple submodels, which may be different layers of a model or independent model, which may have a different structural form, e.g., a combination of a neural network and a support vector machine (SVM).

The term “machine learning model” refers to a trained computational model that is built from a training process in the machine learning from the data. The trained machine learning model is applied during the predication (inference) stage by the computer that gives computer the capability to perform certain tasks (e.g., detect and classify the objects) on its own. Examples of machine learning models include ResNet, DenseNet, etc. which are also named as “deep learning models” because of the layered depth in their network structure. Examples of machine learning models include, kernel-based regressions, adaptive basis regression or classification, Bayesian methods, ensemble methods, logistic regression and extensions, Gaussian processes, support vector machines (SVMs), a probabilistic model, and a probabilistic graphical model. A machine learning model can further include feature engineering (e.g., gathering of features into a data structure such as a 1, 2, or greater dimensional vector) and feature representation (e.g., processing of data structure of features into transformed features to use in training for inference of a classification).

The term neural network as referred to herein is to be construed as including a machine learning model patterned after a network of non-biological neurons that can be trained to learn non-linear functions based on training input. In particular, the term neural network can include a model of interconnected digital neurons that communicate and learn to approximate complex functions and generate outputs based on inputs provided to the model. A neural network can include an algorithm that implements deep learning techniques, that is, machine learning that utilizes a set of algorithms to attempt to model high-level abstractions in data. A neural network can include a variety of deep learning models, including convolutional neural networks, deep belief networks, or deep stacking networks.

The term regression model as referred to herein is to be construed as including a statistical model for estimating relationship among parameters. For instance, a “regression model” includes a linear regression or a logistic regression that estimates a parameter for a function based on independent variables. A regression model may likewise use Stochastic Gradient Descent, Adaptive Gradient Algorithm (“AdaGrad”), Adaptive Moment Estimation (“Adam”), Alternating Direction Method of Multipliers (“ADMM”), or other optimization algorithms.

The term “convolution” refers to a particular mathematical operation on two functions (f and g) to produce a third function that expresses how the shape of one is modified by the other.

The term “convolutional neural network” refers to a class of multilayer feed-forward artificial neural networks, most commonly applied to analyzing visual images utilizing convolution in its operations.

The terms method and process as used herein are to be construed as including any sequence of steps or constituent actions, regardless a specific timeline for the performance thereof. The particular steps or constituent actions of any given method or process are not necessarily in the order they are presented in the claims, description or flowcharts in the drawings, unless the context clearly dictates otherwise. Any particular step or constituent action included in a given method or process may precede or follow any other particular step or constituent action in such method or process, unless the context clearly dictates otherwise. Any particular step or constituent action and/or a combination thereof in any method or process may be performed iteratively, before or after any other particular step or action in such method or process, unless the context clearly dictates otherwise. Moreover, some steps or constituent actions and/or a combination thereof may be combined, performed together, performed concomitantly and/or simultaneously and/or in parallel, unless the context clearly dictates otherwise. Moreover, some steps or constituent actions and/or a combination thereof in any given method or process may be skipped, omitted, spared and/or opted out, unless the context clearly dictates otherwise.

In the specification or claims herein, any term signifying an action or operation, such as: a verb, whether in base form or any tense, gerund or present/past participle, is not to be construed as necessarily to be actually performed but rather in a constructive manner, namely, as to be performed merely optionally or potentially.

The term substantially as used herein is a broad term, and is to be given its ordinary and customary meaning to a person of ordinary skill in the art (and is not to be limited to a special or customized meaning), and refers without limitation to being largely but not necessarily entirely of that quantity or quality which is specified.

The term essentially means that the composition, method, or structure may include additional ingredients, stages and or parts, but only if the additional ingredients, the stages and/or the parts do not materially alter the basic and new characteristics of the composition, method or structure claimed.

As used herein, the term essentially changes a specific meaning, meaning an interval of plus or minus ten percent (+10%). For any embodiments disclosed herein, any disclosure of a particular value, in some alternative embodiments, is to be understood as disclosing an interval approximately or about equal to that particular value (i.e., +10%).

As used herein, the terms about or approximately modify a particular value, by referring to a range equal to the particular value, plus or minus twenty percent (+20%). For any of the embodiments disclosed herein, any disclosure of a particular value, can, in various alternate embodiments, also be understood as a disclosure of a range equal to about that particular value (i.e., +20%).

As used herein, the term or is an inclusive or operator, equivalent to the term and/or, unless the context clearly dictates otherwise; whereas the term and as used herein is also the alternative operator equivalent to the term and/or, unless the context clearly dictates otherwise.

It should be understood, however, that neither the briefly synopsized summary nor particular definitions hereinabove are not to limit interpretation of the invention to the specific forms and examples but rather on the contrary are to cover all modifications, equivalents and alternatives falling within the scope of the invention.

### DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a flowchart of a computer implemented method of searching, sorting, and retrieving documents, according to some embodiments of the presently disclosed subject matter;

FIG. 1B is a flowchart of a computer implemented method of searching, sorting, and retrieving documents, according to some other embodiments of the presently disclosed subject matter;

FIG. 2 is a block diagram of a computer system for searching, sorting, and retrieving documents, according to some embodiments of the presently disclosed subject matter;

FIG. 3 is a flowchart of an example of an experimental method of searching, sorting, and retrieving documents using a non-relevant input document, according to some embodiments of the presently disclosed subject matter;

FIG. 4 is a schematic diagram of an example of computing environment and/or computing device.

### DETAILED DISCLOSURE OF EMBODIMENTS

Illustrative embodiments of the invention are described below. In the interest of clarity, not all features of actual implementation are described in this specification. It should be appreciated that various features or elements described in the context of some embodiment may be interchangeable with features or elements of any other embodiment described in the specification. Moreover, it will be appreciated that for the development of any actual embodiment, numerous implementation-specific decisions must be made to achieve the developers' specific goals, such as compliance with technology- or business-related constraints, which may vary from one implementation to another, and the effort of such a development might be complex and time-consuming, but would nevertheless be a routine undertaking for those of ordinary skill in the art having the benefit of this disclosure.

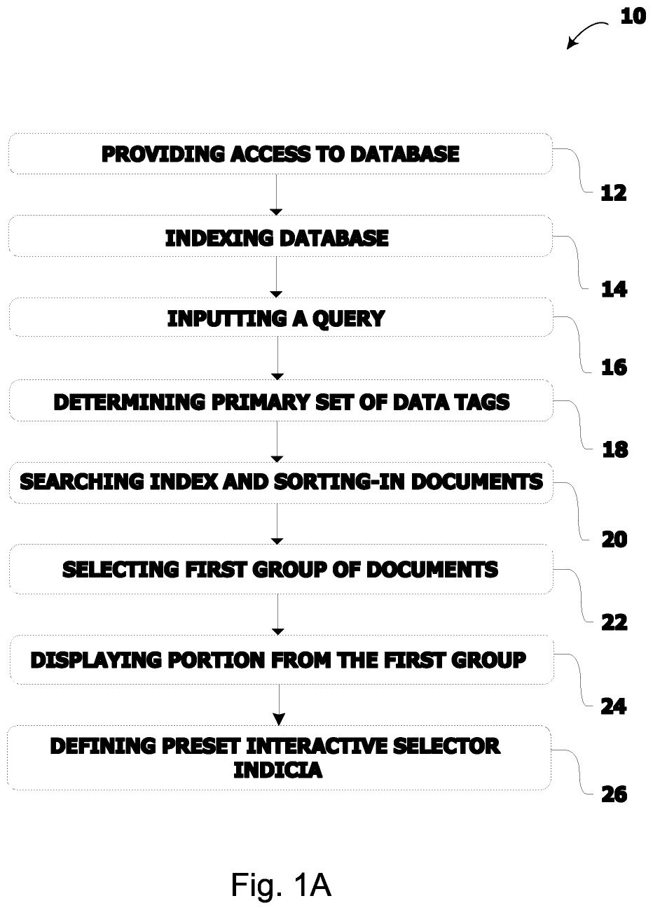

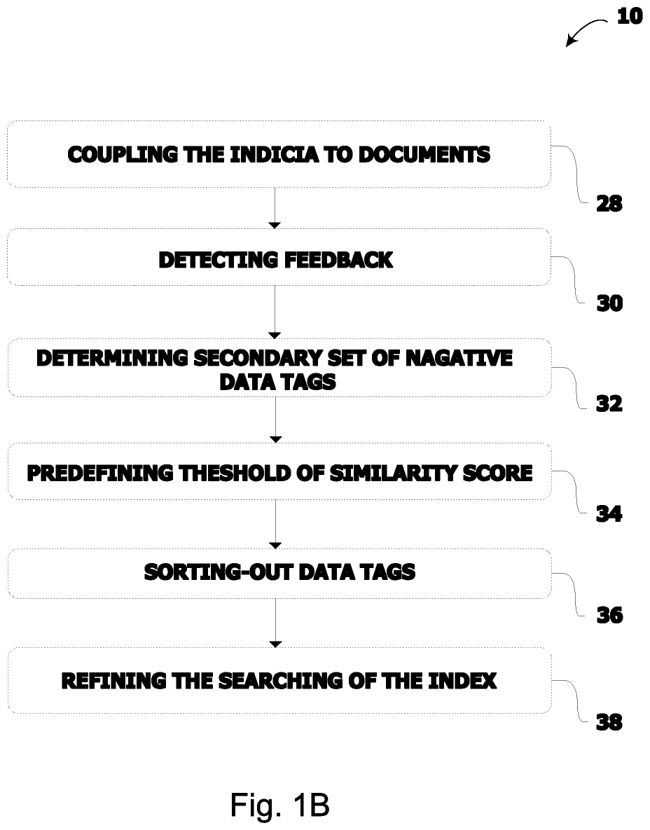

In accordance with some embodiments of the presently disclosed subject matter, reference is now made to FIGS. 1A and 1B, showing a flowchart of computer implemented method 10 of searching, sorting, and retrieving documents. The method described herein with reference to and as illustrated in FIGS. 1A and 1B comprises various features that may be interchangeable with elements of any other embodiment described in the specification.

In some embodiments, method 10 commences at step 12 of providing access to a database containing a plurality of documents with distinct content.

In some embodiments, method 10 further comprises step 14 of indexing the database, thereby forming an index of the database, in which each one of the plurality of documents with the distinct content is associated with several data tags, from a repository of predefined data tags. In some embodiments, step 12 of providing an access to a database of method 10 further comprises providing an access to the index of the pre-indexed database, rather than constructing the index of the database ab initio.

In some embodiments, method 10 further comprises step 16 of inputting, through a human-machine interface of a computer terminal a query, related to a subject of interest. In some embodiments, the inputted query comprises a sematic query, whereas in other embodiments the query comprises an input document. In some embodiments, method 10 further includes step 18 of determining a primary set of positive data tags, from the repository of predefined data tags, related to the inputted query. The repository of predefined data tags is optionally predefined deterministically, adaptively and/or by a trained machine learning model.

In some embodiments, method 10 further comprises step 20 of searching the index of the database and sorting-in the index entries of documents from the database comprising at least one data tag, from the primary set of positive data tags, related to the query, determined at step 18. In some embodiments, method 10 further includes step 22 of selecting, from the index of the documents in the database, into a first group of documents, the documents comprising at least one positive data tag in the index thereof, from the primary set of positive data tags, related to the query.

In some embodiments, step 22 further comprises determining the similarity score, between a first vector, collectively representing the primary set of positive data tags related to the query, and a second vector, collectively representing each one of the plurality of documents in the database. In some embodiments, step 22 further comprises determining whether the similarity score, exceeds a predetermined threshold of inclusion criterion for primary searching.

In some embodiments, method 10 further comprises step 24 of displaying on a graphical user interface of a computer monitor at least a portion from the first group of documents, comprising at least one data tag from the primary set of positive data tags related to the query associated herewith in the index thereof. In some embodiments, step 24 of method 10 comprises displaying, on a graphical user interface of a computer monitor, the snippets and/or synopses of at least a portion from the aforementioned first group of documents.

In some embodiments, method 10 further includes step 26 of defining preset interactive selector indicia, comprising a positive feedbacking indicium and a negative feedbacking indicium. In some embodiments, the preset interactive selector indicia comprises a graphical object, displayed on the graphical user interface of the computer monitor. In some embodiments, the preset interactive selector indicia are displayable on the computer monitor, on which at least the aforementioned portion from the first group of documents is displayed.

In some embodiments, method 10 further comprises step 28 of coupling the preset interactive selector indicia to each one of the documents from the first group of documents, comprising at least one data tag from the primary set of positive data tags related to the query. In some embodiments, step 28 of method 10 comprises displaying the preset interactive selector indicia. In some embodiments, step 28 of method 10 comprises displaying the preset interactive selector indicia respectively alongside and/or otherwise associated with the monitor snippets and/or synopses, of the documents from the first group of displayed on the graphical user interface of the computer. In some embodiments, the preset interactive selector indicia is typically displayable alongside the snippets and/or synopses of at least a portion from the aforementioned first group of documents.

In some embodiments, method 10 further includes step 30 of detecting at least one feedback from the human-machine interface of a computer terminal, selected from the group consisting of: an interaction with the positive feedbacking indicium and interaction with negative feedbacking indicium. In some embodiments, method 10 further comprises step 32 of determining a secondary set of negative data tags, from the repository of predefined data tags, associated with a document in the database for which the interaction with the negative feedbacking indicium on the computer terminal human-machine interface has been detected.

In some embodiments, method 10 further includes step 34 of predefining a threshold of similarity score, as an inclusion criterion for further searching. In some embodiments, method 10 further includes step 34 of predefining a threshold of similarity score, as an exclusion criterion for further searching. In some embodiments, step 34 comprises defining the threshold of similarity score for the secondary set of negative data tags, as an exclusion criterion for further searching, as exceeding the threshold of similarity score of the primary set of positive data tags related to the query.

In some embodiments, method 10 further comprises step 36 of sorting-out from the secondary set of negative data tags, associated with the document in the database for which the interaction with the negative feedbacking indicium was detected, any data tags that do not attain the inclusion criterion of similarity score between the secondary set of negative data tags and the primary set of positive data tags, thereby forming a tertiary set of sorted-out negative data tags. In some embodiments, method 10 further comprises step 36 of sorting-out from the secondary set of negative data tags, any data tags that attain the exclusion criterion of similarity score between the secondary set of negative data tags and the primary set of positive data tags, thereby forming a tertiary set of sorted-out negative data tags.

In some embodiments, the similarity score between the secondary set of negative data tags and the primary set of positive data tags comprises a distance between a first vector collectively representing the primary set of positive data tags and a second vector collectively representing the secondary set of negative data tags. In some embodiments, the similarity score is determined by a cosign similarity function, as an angular distance between the first vector and the second vector. In some embodiments, the similarity score is determined by a cosign similarity function, as an angular distance between the first vector and the second vector, further disregarding the lengths of the first and the second vectors.

In some embodiments, method 10 further includes step 38 of refining the searching of the index, by a combination of: including any documents in the database that are associated with at least one data tag from the primary set of positive data tags related to the query, and excluding any documents in the database that that are associated with at least one data tag from the tertiary set of sorted-out negative data tags. In some embodiments, a plurality of tags are summed-up into a singular vector.

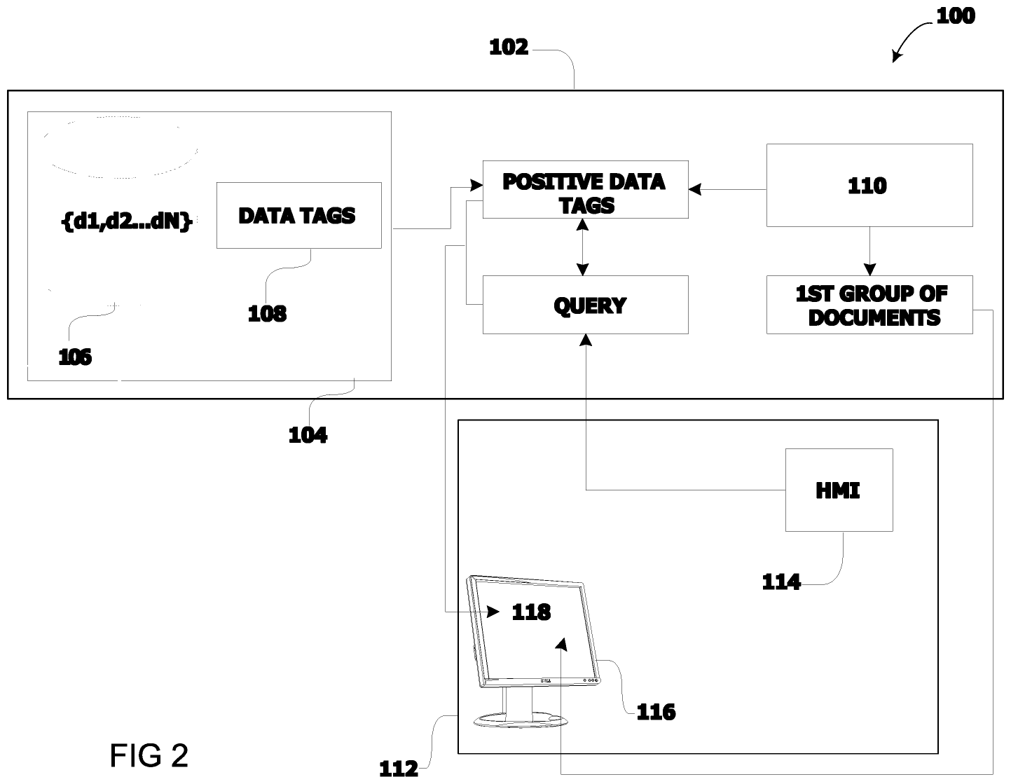

In accordance with some embodiments of the presently disclosed subject matter, reference is now made to FIG. 2, showing a block diagram of computer system 100 for searching, sorting, and retrieving documents. The system described herein with reference to and as illustrated in FIG. 2 comprises various features that may be interchangeable with elements of any other embodiment described in the specification.

In some embodiments, computer system 100 comprises server 102. Server 102 comprises computer-readable storage medium 104. Computer-readable storage medium 104 comprises database D (106) containing a plurality of documents d with distinct content, as represented by the following formula:

D←{dᵢ,d₂. . . d_{N}}

In some embodiments, computer-readable storage medium 104 further comprises repository 108 of predefined data tags and an index of the database or an access index of a pre-indexed database, in which each one of the plurality of documents with the distinct content is associated with several data tags, from repository 108.

In some embodiments, system 100 further comprises microprocessor 110. Microprocessor 110 is configured for determining a primary set of positive data tags, from repository 108 of predefined data tags, associated with an input query related to a subject of interest, where the input query is optionally a sematic query and/or input document.

In some embodiments, microprocessor 110 is further configured for searching the index and sorting-in the entries of documents comprising at least one data tag from the primary set of positive data tags, related to the query. In some embodiments, microprocessor 110 is configured for selecting from the index a first group of documents, comprising at least one positive data tag from the primary set of positive data tags, related to the query.

In some embodiments, microprocessor 110 is configured for defining preset interactive selector indicia, comprising a positive feedbacking indicium and a negative feedbacking indicium. In some embodiments, microprocessor 110 is further configured for coupling the preset interactive selector indicia to each one of the documents from the first group of documents, comprising at least one data tag from the primary set of positive data tags related to the input query.

In some embodiments, microprocessor 110 is configured for detecting at least one feedback from the human-machine interface of the computer terminal, selected from the group consisting of: an interaction with the positive feedbacking indicium and interaction with negative feedbacking indicium. In some embodiments, microprocessor 110 is configured for determining a secondary set of negative data tags, from the repository of predefined data tags, associated with a document in the database for which the interaction with the negative feedbacking indicium on the computer terminal human-machine interface 114 has been detected.

In some embodiments, microprocessor 110 is configured for predefining a threshold of similarity score between: the secondary set of negative data tags, associated with the document in the database for which the interaction with the negative feedbacking indicium was detected, and the primary set of positive data tags related to the query, as an inclusion or exclusion criterion for further searching.

In some embodiments, microprocessor 110 is configured for sorting-out from the secondary set of negative data tags, associated with the document in the database for which the interaction with the negative feedbacking indicium was detected, any data tags that do not attain the inclusion criterion or do attain the exclusion criterion, of similarity score between the secondary set of negative data tags and the primary set of positive data tags, thereby forming a tertiary set of sorted-out negative data tags.

In some embodiments, microprocessor 110 is configured for refining the searching of the index, by including any documents in the database that are associated with at least one data tag from the primary set of positive data tags related to the query, and excluding any documents in the database that that are associated with at least one data tag from the tertiary set of sorted-out negative data tags, which are in turn associated with the document in the database for which the interaction with the negative feedbacking indicium was detected.

In some embodiments, system 100 further comprises end-user computer device 112. Computer device 112 comprises human-machine interface device 114 operationally connected to a computer terminal. Human-machine interface device 114 is configured, inter alia, for the inputting of the input query and/or for forming the interaction with the preset interactive selector indicia.

In some embodiments, computer device 112 further comprises computer monitor 116 configured for displaying graphical user interface 118 thereon, showing at least a portion from the first group of documents, comprising at least one data tag from the primary set of positive data tags related to the input query associated herewith and/or the preset interactive selector indicia.

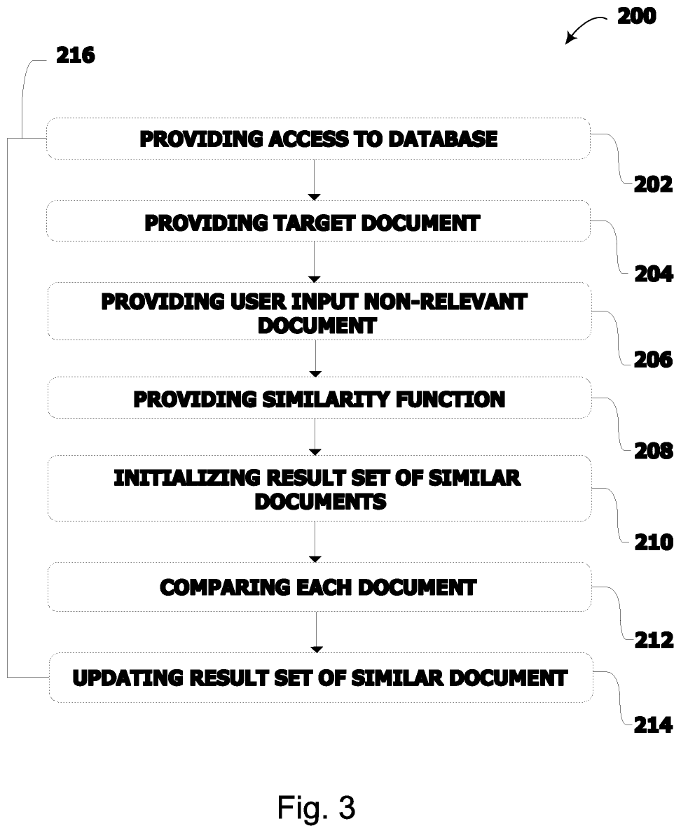

In accordance with some embodiments of the presently disclosed subject matter, reference is now made to FIG. 3, showing a flowchart of an example of method 200 of searching, sorting, and retrieving documents using a non-relevant input document. The method described herein with reference to and as illustrated in FIG. 3 comprises various features that may be interchangeable with elements of any other embodiment described in the specification.

In some embodiments, method 200 commences at step 202 of providing an access to a database D containing a group of documents {dᵢ, d₂ . . . d_{N}} with distinct content, as represented by the following formula:

D←{dᵢ,d₂. . . d_{N}}

In some embodiments, method 200 includes step 204 of providing a target document dₜ. In some embodiments, method 200 further includes step 206 of providing a non-relevant document dᵤ input.

In some embodiments, method 200 yet further comprises step 208 of calculating a similarity function fₛ and providing the similarity function fₛ result, based on features and/or data tags of the non-relevant document dᵤ input. In some embodiments, method 200 still further includes step 210 of initializing a screen and providing a result set of similar documents Sᵣ to the group of documents D.

In some embodiments, method 200 further comprises step 212 of comparing each document of the group of documents D to the target document de as well as to the user non-relevant document input dᵤ using the similarity function fₛ. In some embodiments, method 200 further comprises step 214 of updating the result set of similar documents Sᵣ accordingly to the following:

$$∀ {d}_{i} ∈ D if {f}_{s} ( {d}_{i} , {d}_{u} ) > {f}_{s} ( {d}_{i} , {d}_{t} ) then {S}_{r} ← {S}_{r} \{ {d}_{i} \} \qquad ( 1 )$$

In some embodiments, if the similarity function fₛ of each document dᵢ from the group of documents D to the non-relevant document dᵤ is greater than the similarity function fₛ of each document dᵢ from the group of documents D to the target document dₜ, then each document Sᵣ similar to document dᵢ from are subtracted and/or removed the group of documents D.

In some embodiments, method 200 further comprises iterative step 216 of repeating the search of documents group of documents in D, such that the results set of similar documents Sᵣ contains filtered documents similar to the target document dₜ but at the same time distinct from the non-relevant document dᵤ.

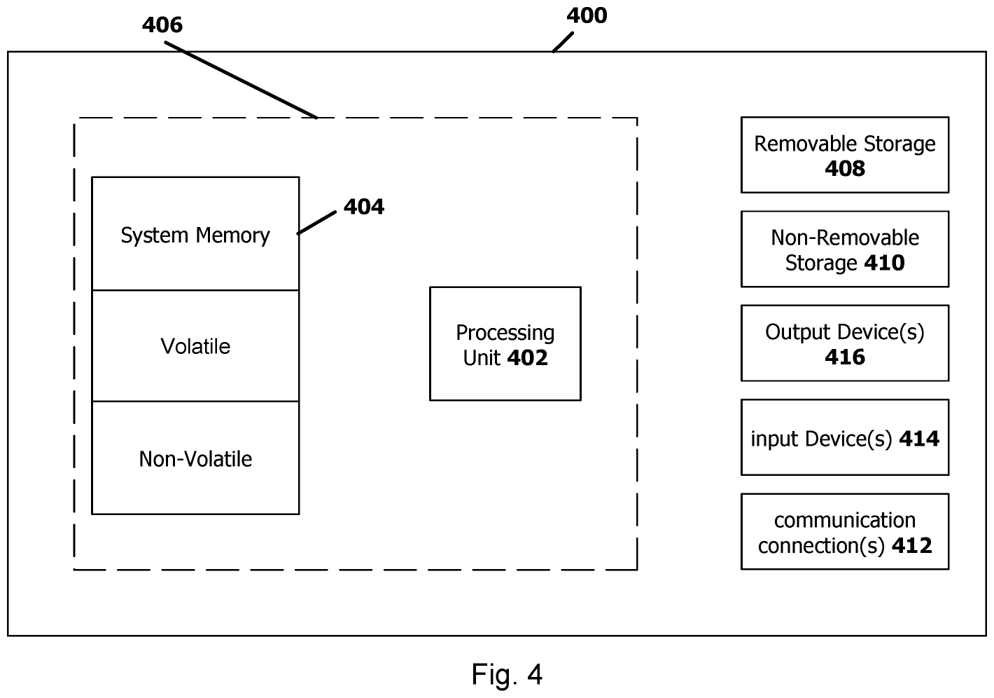

With reference to FIG. 4, an example of a system for implementing aspects described herein includes a computing device, such as computing device 400. In its most basic configuration, computing device 400 typically includes at least one processing unit 402 and memory 404. Depending on the exact configuration and type of computing device, memory 404 may be volatile, such as random access memory (RAM), non-volatile, such as read-only memory (ROM), flash memory, etc., or any combination thereof. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by computing device 400 and include both volatile and non-volatile media, and removable and non-removable media. Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communications connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although examples of implementations may include utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be implemented across a plurality of devices. Such devices might include PCs, network servers, and handheld devices, for example.

### Working Example

Examples of experimental performance of the method demonstrating how the features and/or data tags extracted from an input and non-relevant feedbacked documents are used to filter documents.

Initially, the data tags “cat” and “dog” were determined to be associated with or representing the target inputted document dₜ←{cat, dog}.

Then, a document set of two documents, associated with data tags cat, dog and elephant for document d₁ and cat, dog and house for document d₂ have been retrieved from the database:

$${D}^{′} = \{ {d}_{1} = \{ cat , dog , elephant \} , {d}_{2} = \{ cat , dog , house \} \} .$$

Subsequently to that, an interaction with negative feedbacking indicum coupled to document d₂ has been detected. The document d₂ has then been classified as non-relevant document and the data tag house was subsequently determined not to attain the inclusion criteria and thus was consequently excluded from the tertiary set, of filtered out data tags, for similar documents Sᵣ from the document set D in further searching dᵤ={house}.

To filter documents only with animals, the similarity function fₛ was calculated, in this particular working example, by the following:

$${f}_{s} ( {d}_{x} , {d}_{y} ) = \vert {d}_{x} ∩ {d}_{y} ∩ {d}_{u} \vert \qquad ( 2 )$$

Similarity function fₛ for document d₁={cat, dog, elephant} and the non-relevant document dᵤ= {house} was used. The similarity function between the document d1={cat, dog, elephant} and the non-relevant document dᵤ= {house} was calculated by the following:

$${f}_{s} ( {d}_{1} , {d}_{u} ) = \vert \{ cat , dog , house \} ∩ \{ house \} ∩ \{ house \} \vert = \vert \{ \} ∩ \{ house \} \vert = \vert \{ \} \vert = 0 \qquad ( 3 )$$

Similarity function fₛ for document d₁={cat, dog, elephant} and the target document dₜ←{cat, dog} was used. The similarity function between the document d₁={cat, dog, elephant} and the target document dₜ←{cat, dog} was calculated by the following:

$${f}_{s} ( {d}_{1} , {d}_{t} ) = \vert \{ cat , dog , house \} ∩ \{ cat , dog \} ∩ \{ house \} \vert = \vert \{ cat , dog \} ∩ \{ house \} \vert = \vert \{ \} \vert = 0 \qquad ( 4 )$$

Since fₛ(d₁, dᵤ)>fₛ(d₁, dₜ) then d₁= {cat, dog, elephant} was not removed from the result set, and Sᵣ=D was still obtained. In other words, since the similarity function between the document d₁= {cat, dog, elephant} and the non-relevant document dᵤ= {house} was not greater than the similarity function between the document d₁= {cat, dog, elephant} and the target document dₜ←{cat, dog}, the document d₁ associated with the data tags cat, dog and elephant, was not removed from the result set, and similar documents Sᵣ among the document set D did not change.

However, when similarity function fₛ for document d₂= {cat, dog, house} was determined, the similarity function between the document d₂= {cat, dog, house} and the non-relevant document dᵤ= {house} was calculated by the following:

$${f}_{s} ( {d}_{2} , {d}_{u} ) = \vert \{ cat , dog , house \} ∩ \{ house \} ∩ \{ house \} \vert = \vert \{ house \} ∩ \{ house \} \vert = \vert \{ house \} \vert = 1 \qquad ( 5 )$$

The similarity function fₛ between document d₂= {cat, dog, house} and the target document dₜ←{cat, dog} was calculated by the following:

$${f}_{s} ( {d}_{2} , {d}_{t} ) = \vert \{ cat , dog , house \} ∩ \{ cat , dog \} ∩ \{ house \} \vert = \vert \{ cat , dog \} ∩ \{ house \} \vert = \vert \{ \} \vert = 0 \qquad ( 6 )$$

Since fₛ (d₂, dᵤ)>fₛ (d₂, dₜ) then d₂= {cat, dog, house} was filtered out from the results and the result set became Sᵣ+D {d₂}=>Sᵣ-{d₂}. In other words, since the similarity function between the document d₂= {cat, dog, house} and the non-relevant document dᵤ= {house} was greater than the similarity function between the document d₂= {cat, dog, house} and target document dₜ←{cat, dog}, the document d₂ associated with the data tags=cat, dog and house, was removed and filtered out from the document set D, whereas similar documents Sᵣ, among the document set D hasn't included the document d₂= {cat, dog, house}.

It was noted that using the non-relevant feedbacked document, the result set contained only documents with animals. When the keywords {cat, dog} from the target document de to filter similar documents would have been used, d₂ would not have been filtered out, since both d₁ and d₂ both related to the data tags cat and dog.

It will be appreciated by persons skilled in the art of the invention that various features and/or elements elaborated in the context of a specific embodiment described hereinabove and/or referenced herein and/or illustrated by a particular example in a certain drawing enclosed hereto, whether method, system, device or product, is/are interchangeable with features and/or elements of any other embodiment described in the specification and/or shown in the drawings. Moreover, persons skilled in the art of the invention would appreciate that the presently disclosed subject matter is not limited by what has been particularly shown and described hereinabove. Rather the scope of the invention is defined by the claims which follow.

### INDEX OF REFERENCE NUMERALS

Within the specification hereinabove, the following numerals, inter alia, were used to denote the particular constituents in the appended drawings:
10-method of searching, sorting, and retrieving documents
12-providing an access to a database
14-indexing the database
16-inputting a query
18-determining a primary set of positive data tags
20-searching the index and sorting-in entries
22-selecting from the index a first group of documents
24-displaying first group of documents
26-defining preset interactive selector indicia
28-coupling the preset interactive selector indicia
30-detecting feedback
32-determining a secondary set of negative data tags
34-predefining a threshold of similarity score
36-sorting-out from the secondary set of negative data tags
38-refining the searching of the index
100-system for searching, sorting, and retrieving documents
102-server
104-computer-readable storage medium
106-database
108-repository
110-microprocessor
112-computer device
114-human-machine interface device
116-computer monitor
118-graphical user interface
200-method of searching, sorting, and retrieving documents using a non-relevant input document
202-providing an access to a database
204-providing a target document dₜ
206-providing a user input non-relevant document dᵤ
208-providing a similarity function fₛ
210-initializing a result set of similar documents Sᵣ
212-comparing each document of the group of documents D
214-updating result set of similar documents Sᵣ
216-iterating the total documents in D

1. A computer implemented method of searching, sorting, and retrieving documents comprises:
(a) providing an access to a database containing a plurality of documents with distinct content;
(b) indexing said database, thereby forming an index of said database, wherein each one of said plurality of documents with said distinct content is associated with several data tags, from a repository of predefined data tags;
(c) inputting through a human-machine interface of a computer terminal a query related to a subject of interest, wherein said query is at least one member selected from the group consisting of: a sematic query and input document;
(d) determining a primary set of positive data tags, from said repository of predefined data tags, related to said query;
(e) searching said index and sorting-in documents comprising at least one data tag from said primary set of positive data tags, related to said query, subsequently to said determining;
(f) selecting from said index a first group of documents, comprising said at least one positive data tag from said primary set of positive data tags, related to said query, subsequently to said searching;
(g) displaying on a graphical user interface of a computer monitor at least a portion from said first group of documents, comprising said at least one data tag from said primary set of positive data tags related to said query associated herewith in said index, subsequently to said selecting;
(h) defining preset interactive selector indicia, comprising a positive feedbacking indicium and a negative feedbacking indicium;
(i) coupling said preset interactive selector indicia to each one of said documents from said first group of documents, comprising said at least one data tag from said primary set of positive data tags related to said query;
(j) detecting at least one feedback from said human-machine interface of said computer terminal, selected from the group consisting of: an interaction with said positive feedbacking indicium and interaction with negative feedbacking indicium;
(k) determining a secondary set of negative data tags, from said repository of predefined data tags, associated with a document in said database for which said interaction with said negative feedbacking indicium on said computer terminal human-machine interface has been detected, during said detecting;
(l) predefining a threshold of similarity score between said secondary set of negative data tags, associated with said document in said database for which said interaction with said negative feedbacking indicium was detected, and said primary set of positive data tags related to said query, as an inclusion criterion for further searching;
(m) sorting-out from said secondary set of negative data tags, associated with said document in said database for which said interaction with said negative feedbacking indicium was detected, any data tags that do not attain said inclusion criterion of similarity score between said secondary set of negative data tags and said primary set of positive data tags, thereby forming a tertiary set of sorted-out negative data tags; and
(n) refining said searching of said index, by a combination of:
(i) including any documents in said database that are associated with at least one data tag from said primary set of positive data tags related to said query; and
(ii) excluding any documents in said database that that are associated with at least one data tag from said tertiary set of sorted-out negative data tags, associated with said document in said database for which said interaction with said negative feedbacking indicium was detected.

2. The method according to claim 1, wherein a plurality of tags are summed-up into a singular vector.

3. The method according to claim 1, wherein said similarity score between said secondary set of negative data tags and said primary set of positive data tags comprises a distance between a first vector representing said primary set of positive data tags and a second vector representing said secondary set of negative data tags.

4. The method according to claim 3, wherein said similarity score is determined by a cosign similarity function, as an angular distance between said first vector and said second vector, disregarding said first vector and said second vector.

5. The method according to claim 1, wherein said selecting of said first group of documents, further comprises determining that a similarity score, between a first vector collectively representing said primary set of positive data tags related to said query and a second vector collectively representing each one of said plurality of documents in said database, exceeds a predetermined threshold of inclusion criterion for primary searching.

6. The method according to claim 1, wherein said preset interactive selector indicia comprises a graphical object, displayed on said graphical user interface of said computer monitor, wherein at least said portion from said first group of documents is displayed.

7. A computer system for searching, sorting, and retrieving documents comprises:
(a) a server comprising:
(I) computer-readable storage medium comprising:
(i) a database containing a plurality of documents with distinct content;
(ii) a repository of predefined data tags;
(iii) an index of said database, wherein each one of said plurality of documents with said distinct content is associated with several data tags, from said repository;
(II) a microprocessor configured for:
(i) determining a primary set of positive data tags, from said repository of predefined data tags, associated with a query related to a subject of interest, wherein said query is at least one member selected from the group consisting of: a sematic query and input document;
(ii) searching said index and sorting-in documents comprising at least one data tag from said primary set of positive data tags, related to said query;
(iii) selecting from said index a first group of documents, comprising said at least one positive data tag from said primary set of positive data tags, related to said query, subsequently to said searching;
(iv) defining preset interactive selector indicia, comprising a positive feedbacking indicium and a negative feedbacking indicium;
(v) coupling said preset interactive selector indicia to each one of said documents from said first group of documents, comprising said at least one data tag from said primary set of positive data tags related to said query;
(vi) detecting at least one feedback from said human-machine interface of said computer terminal, selected from the group consisting of: an interaction with said positive feedbacking indicium and interaction with negative feedbacking indicium;
(vii) determining a secondary set of negative data tags, from said repository of predefined data tags, associated with a document in said database for which said interaction with said negative feedbacking indicium on said computer terminal human-machine interface has been detected, during said detecting;
(viii) predefining a threshold of similarity score between: said secondary set of negative data tags, associated with said document in said database for which said interaction with said negative feedbacking indicium was detected, and said primary set of positive data tags related to said query, as an inclusion criterion for further searching;
(ix) sorting-out from said secondary set of negative data tags, associated with said document in said database for which said interaction with said negative feedbacking indicium was detected, any data tags that do not attain said inclusion criterion of similarity score between said secondary set of negative data tags and said primary set of positive data tags, thereby forming a tertiary set of sorted-out negative data tags;
(x) refining said searching of said index, by including any documents in said database that are associated with at least one data tag from said primary set of positive data tags related to said query, and excluding any documents in said database that that are associated with at least one data tag from said tertiary set of sorted-out negative data tags, associated with said document in said database for which said interaction with said negative feedbacking indicium was detected;
(b) a computing device comprising:
(I) a human-machine interface device operationally connected to a computer terminal, configured for inputting said query;
(II) a computer monitor configured for displaying a graphical user interface including at least a portion from said first group of documents, comprising said at least one data tag from said primary set of positive data tags related to said query associated herewith.

8. The system according to claim 7, wherein a plurality of tags are summed-up, into a singular vector.

9. The system according to claim 7, wherein said similarity score between said secondary set of negative data tags and said primary set of positive data tags comprises a distance between a first vector representing a collection of said primary set of positive data tags and a second vector representing a collection of said secondary set of negative data tags.

10. The system according to claim 9, wherein said similarity score is determined by a cosign similarity function, as an angular distance between said first vector and said second vector, disregarding said first vector and said second vector.

11. The system according to claim 7, wherein said selecting of said first group of documents, further comprises determining that a similarity score, between a first vector collectively representing said primary set of positive data tags related to said query and a second vector collectively representing each one of said plurality of documents in said database, exceeds a predetermined threshold of inclusion criterion for primary searching.

12. The system according to claim 7, wherein said preset interactive selector indicia comprises a graphical object, displayed on said graphical user interface of said computer monitor, wherein at least said portion from said first group of documents is displayed.

13. A computer-readable storage medium, having computer-executable instructions stored thereon which, when executed by a computer micro-processor of a system for searching, sorting, and retrieving documents, causing said micro-processor of said system:
(a) providing an access to a database containing a plurality of documents with distinct content;
(b) indexing said database, thereby forming an index of said database, wherein each one of said plurality of documents with said distinct content is associated with several data tags, from a repository of predefined data tags;
(c) inputting through a human-machine interface on a computer terminal a query related to a subject of interest, wherein said query is at least one member selected from the group consisting of: a sematic query and input document;
(d) determining a primary set of positive data tags, from said repository of predefined data tags, related to said query;
(e) searching said index and sorting-in documents comprising at least one data tag from said primary set of positive data tags, related to said query, subsequently to said determining;
(f) selecting from said index a first group of documents, comprising said at least one positive data tag from said primary set of positive data tags, related to said query, subsequently to said searching;
(g) displaying on a graphical user interface of a computer monitor at least a portion from said first group of documents, comprising said at least one data tag from said primary set of positive data tags related to said query associated herewith in said index, subsequently to said selecting;
(h) defining preset interactive selector indicia, comprising a positive feedbacking indicium and a negative feedbacking indicium;
(i) coupling said preset interactive selector indicia to each one of said documents from said first group of documents, comprising said at least one data tag from said primary set of positive data tags related to said query;
(j) detecting at least one feedback from said human-machine interface of said computer terminal, selected from the group consisting of: an interaction with said positive feedbacking indicium and interaction with negative feedbacking indicium;
(k) determining a secondary set of negative data tags, from said repository of predefined data tags, associated with a document in said database for which said interaction with said negative feedbacking indicium on said computer terminal human-machine interface has been detected, during said detecting;
(l) predefining a threshold of similarity score between said secondary set of negative data tags, associated with said document in said database for which said interaction with said negative feedbacking indicium was detected, and said primary set of positive data tags related to said query, as an inclusion criterion for further searching;
(m) sorting-out from said secondary set of negative data tags, associated with said document in said database for which said interaction with said negative feedbacking indicium was detected, any data tags that do not attain said inclusion criterion of similarity score between said secondary set of negative data tags and said primary set of positive data tags, thereby forming a tertiary set of sorted-out negative data tags; and
(n) refining said searching of said index, by a combination of:
(i) including any documents in said database that are associated with at least one data tag from said primary set of positive data tags related to said query, and
(ii) excluding any documents in said database that that are associated with at least one data tag from said tertiary set of sorted-out negative data tags, associated with said document in said database for which said interaction with said negative feedbacking indicium was detected.

14. The computer-readable storage medium according to claim 13, wherein a plurality of tags are summed-up into a singular vector.

15. The computer-readable storage medium according to claim 13, wherein said similarity score between said secondary set of negative data tags and said primary set of positive data tags comprises a distance between a first vector representing a collection of said primary set of positive data tags and a second vector representing a collection of said secondary set of negative data tags.

16. The computer-readable storage medium according to claim 15, wherein said similarity score is determined by a cosign similarity function, as an angular distance between said first vector and said second vector, disregarding said first vector and said second vector.

17. The computer-readable storage medium according to claim 13, wherein said selecting of said first group of documents, further comprises determining that a similarity score, between a first vector collectively representing said primary set of positive data tags related to said query and a second vector collectively representing each one of said plurality of documents in said database, exceeds a predetermined threshold of inclusion criterion for primary searching.

18. The computer-readable storage medium according to claim 13, wherein said preset interactive selector indicia comprises a graphical object, displayed on said graphical user interface of said computer monitor, wherein at least said portion from said first group of documents is displayed.
